(19) United States
(12) Patent Application Publication
(10) Pub. No.: US 2026/0186146 A1
(43) Pub. Date: Jul. 2, 2026

(54) WIND OBSERVATION DEVICE, WIND OBSERVATION METHOD, AND WIND OBSERVATION SYSTEM

(71) Applicant: Mitsubishi Electric Corporation, Tokyo (JP)

(72) Inventors: Nobuki KOTAKE, Tokyo (JP); Yusuke ITO, Tokyo (JP)

(73) Assignee: Mitsubishi Electric Corporation, Tokyo (JP)

(21) Appl. No.: 19/548,495

(22) Filed: Feb. 24, 2026

Related U.S. Application Data
(63) Continuation of application No. PCT/JP2023/038414, filed on Oct. 25, 2023.

(51) Int. Cl. G01S 17/95

(52) U.S. Cl. CPC G01S 17/95

(57) ABSTRACT

A wind observation device includes processing circuitry configured to: acquire a reception signal of each scattered light beam from a conical scanning sensor to repeatedly emit a laser beam toward a wind observation region and to receive scattered light of each laser beam scattered by aerosol present in the wind observation region; shift a frequency of each reception signal having been acquired using a frequency shift amount corresponding to each of a plurality of mutually different wind vectors and to integrate spectra of the plurality of reception signals after the frequency shift for each wind vector; and select a wind vector corresponding to a wind vector in the wind observation region from among the plurality of wind vectors on a basis of the integrated spectrum of the reception signals for each wind vector.

### CROSS REFERENCE TO RELATED APPLICATIONS

This application is a Continuation of PCT International Application No. PCT/JP2023/038414 filed on Oct. 25, 2023, all of which is hereby expressly incorporated by reference into the present application.

### TECHNICAL FIELD

The present disclosure relates to a wind observation device, a wind observation method, and a wind observation system.

### BACKGROUND ART

There is a wind observation device that observes a wind vector in a wind observation region.

As such a wind observation device, for example, Non-Patent Literature 1 discloses a wind observation device that acquires a plurality of reception signals from a conical scanning sensor and calculates a wind vector in a wind observation region on the basis of the plurality of reception signals.

The conical scanning method is a method for switching a laser beam irradiation direction so that a laser beam irradiation position with respect to the wind observation region changes with a lapse of time. The laser beam irradiation position changes so as to surround the center of the wind observation region. The conical scanning sensor repeatedly emits a laser beam toward the wind observation region and receives scattered light of each laser beam scattered by aerosol present in the wind observation region. Then, the sensor outputs a reception signal of each scattered light beam to the wind observation device.

### CITATION LIST

### Non-Patent Literature

Non-Patent Literature 1: Browning K. A., Wexler R. “The Determination of Kinematic Properties of a Wind Field Using Doppler Radar”, Journal of Applied Meteorology, Vol. 7, No. 1, pp. 105-113, 1968.

### SUMMARY OF INVENTION

### Technical Problem

A reception signal of scattered light scattered by aerosol generally has a low signal-to-noise ratio (hereinafter referred to as “SNR”).

The wind observation device disclosed in Non-Patent Literature 1 has a problem that calculation accuracy of a wind vector may deteriorate when an SNR of each reception signal is low. When irradiation positions of a plurality of laser beams are the same, the SNR may be increased by integrating a plurality of reception signals. However, in the conical scanning method, Doppler frequencies of a plurality of scattered light beams may be different from each other because irradiation positions of a plurality of laser beams with respect to a wind observation region are different from each other. Therefore, even if reception signals of the plurality of scattered light beams are integrated, the SNR is not necessarily increased.

The present disclosure has been made to solve the above problems, and an object of the present disclosure is to obtain a wind observation device capable of preventing deterioration of calculation accuracy of a wind vector by increasing an SNR of a reception signal as compared with that of the wind observation device disclosed in Non-Patent Literature 1.

### Solution to Problem

A wind observation device according to the present disclosure includes: processing circuitry configured to: acquire a reception signal of each scattered light beam from a conical scanning sensor to repeatedly emit a laser beam toward a wind observation region and to receive scattered light of each laser beam scattered by aerosol present in the wind observation region; shift a frequency of each reception signal having been acquired using a frequency shift amount corresponding to each of a plurality of mutually different wind vectors stored in advance, in accordance with each of the plurality of wind vectors and to integrate spectra of the plurality of reception signals after the frequency shift corresponding to each reception signal and each of the wind vectors, for each corresponding wind vector; and select a wind vector corresponding to a wind vector in the wind observation region from among the plurality of wind vectors on a basis of the integrated spectrum of the reception signals for each wind vector.

### Advantageous Effects of Invention

According to the present disclosure, it is possible to prevent deterioration of calculation accuracy of a wind vector by increasing an SNR of a reception signal as compared with that of the wind observation device disclosed in Non-Patent Literature 1.

### BRIEF DESCRIPTION OF DRAWINGS

FIG. 1 is a configuration diagram illustrating a wind observation system including a wind observation device 3 according to a first embodiment.

FIG. 2 is a hardware configuration diagram illustrating hardware of the wind observation device 3 according to the first embodiment.

FIG. 3 is a hardware configuration diagram of a computer in a case where the wind observation device 3 is implemented by software, firmware, or the like.

FIG. 4 is a flowchart illustrating a wind observation method which is a processing procedure performed by the wind observation device 3.

FIG. 5A is an explanatory diagram illustrating an irradiation direction of transmission light when each of a sensor 1 and a wind observation region is viewed from a side, and FIG. 5B is an explanatory diagram illustrating an irradiation direction of transmission light when each of the sensor 1 and the wind observation region is viewed from above.

FIG. 6 is an explanatory diagram illustrating a wind vector at an irradiation position of transmission light.

FIG. 7 is an explanatory diagram illustrating a spectrum of reception data S(AZ(n), Rb) whose frequency is not shifted by a first shift processing unit 32a.

FIG. 8 is an explanatory diagram illustrating a spectrum SPC(H(i), W(j), θ(k), n, Rb) of reception data Sᵣₑᵥ(H(i), W(j), θ(k), n, Rb) after frequency shift performed by the first shift processing unit 32a.

FIG. 9 is a configuration diagram illustrating a wind observation system including a wind observation device 3 according to a second embodiment.

FIG. 10 is a hardware configuration diagram illustrating hardware of the wind observation device 3 according to the second embodiment.

FIG. 11 is a configuration diagram illustrating a wind observation system including a wind observation device 3 according to a third embodiment.

FIG. 12 is a hardware configuration diagram illustrating hardware of the wind observation device 3 according to the third embodiment.

FIG. 13 is a configuration diagram illustrating a wind observation system including a wind observation device 3 according to a fourth embodiment.

FIG. 14 is a hardware configuration diagram illustrating hardware of the wind observation device 3 according to the fourth embodiment.

### DESCRIPTION OF EMBODIMENTS

Hereinafter, in order to describe the present disclosure in more detail, embodiments for carrying out the present disclosure will be described with reference to the attached drawings.

### First Embodiment

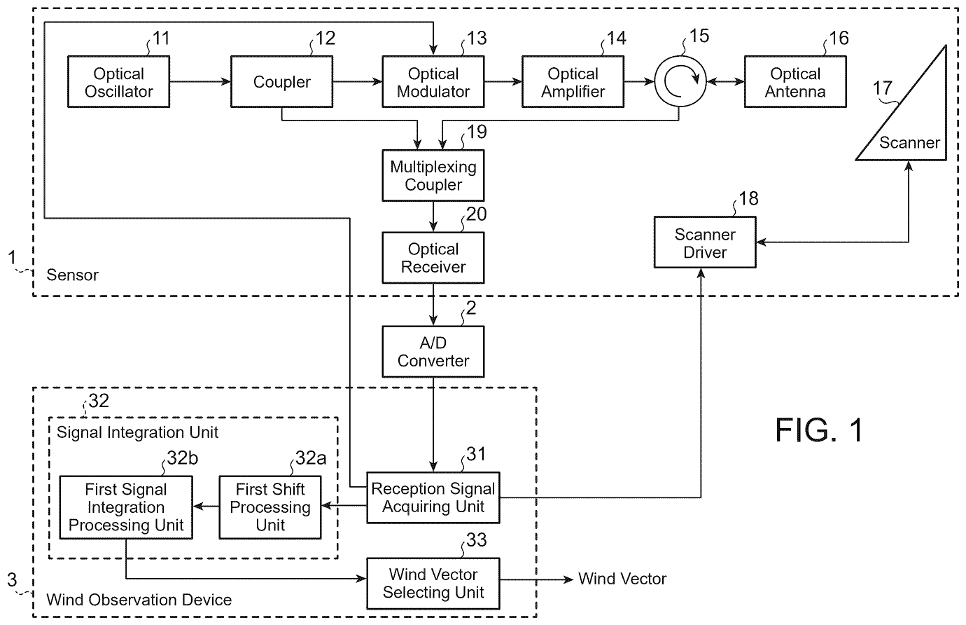

FIG. 1 is a configuration diagram illustrating a wind observation system including a wind observation device 3 according to a first embodiment.

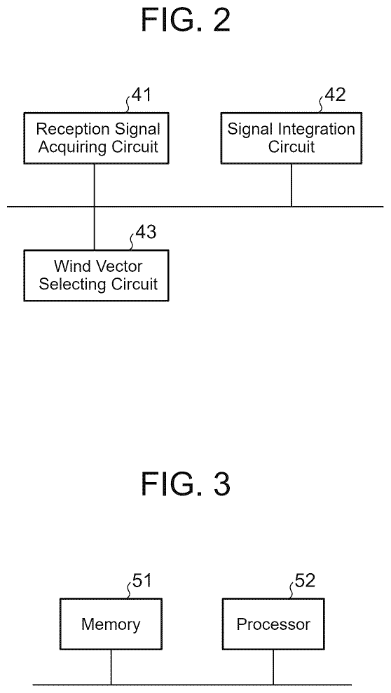

FIG. 2 is a hardware configuration diagram illustrating hardware of the wind observation device 3 according to the first embodiment.

The wind observation system illustrated in FIG. 1 includes a sensor 1, an analogue to digital converter (A/D converter) 2, and the wind observation device 3.

The sensor 1 includes an optical oscillator 11, a coupler 12, an optical modulator 13, an optical amplifier 14, an optical circulator 15, an optical antenna 16, a scanner 17, a scanner driver 18, a multiplexing coupler 19, and an optical receiver 20.

The sensor 1 is a conical scanning sensor.

The sensor 1 repeatedly emits, for example, pulsed light as a laser beam toward a wind observation region.

The sensor 1 receives scattered light of each pulsed light beam scattered by aerosol present in the wind observation region. Then, the sensor 1 outputs a reception signal of each scattered light beam to the wind observation device 3 via the A/D converter 2.

In the wind observation system illustrated in FIG. 1, the sensor 1 emits pulsed light as a laser beam toward the wind observation region. However, this is merely an example, and the sensor 1 may emit, for example, continuous light as a laser beam toward the wind observation region.

The optical oscillator 11 is implemented by, for example, a semiconductor laser or a solid-state laser.

The optical oscillator 11 oscillates a laser beam such as pulsed light, and outputs the laser beam to the coupler 12.

The coupler 12 is implemented by, for example, a molten fiber coupler or a filter type coupler using a dielectric multilayer film filter.

The coupler 12 distributes a laser beam output from the optical oscillator 11 into transmission light and local light.

The coupler 12 outputs the transmission light to the optical modulator 13 and outputs the local light to the multiplexing coupler 19.

The optical modulator 13 is implemented by, for example, an acoust optical frequency shifter (AO frequency shifter) or an optical phase modulator.

The optical modulator 13 shifts a frequency of the transmission light output from the coupler 12 by performing phase modulation processing or frequency modulation processing on the transmission light.

In addition, the optical modulator 13 performs intensity modulation on the transmission light after the frequency shift at a timing of receiving a trigger signal from the wind observation device 3.

The optical modulator 13 outputs the transmission light after the intensity modulation to the optical amplifier 14.

The optical amplifier 14 amplifies the transmission light output from the optical modulator 13 and outputs the amplified transmission light to the optical circulator 15.

The optical circulator 15 is implemented by, for example, a wave plate and a beam splitter.

The optical circulator 15 outputs the transmission light output from the optical amplifier 14 to the optical antenna 16, and outputs scattered light output from the optical antenna 16 to the multiplexing coupler 19.

The optical antenna 16 is implemented by, for example, an optical telescope or a camera lens.

The optical antenna 16 emits the transmission light output from the optical circulator 15.

The optical antenna 16 receives scattered light of the transmission light scattered by aerosol present in the wind observation region.

The optical antenna 16 outputs the scattered light to the optical circulator 15.

The scanner 17 is implemented by, for example, a motor scanner that performs two-axis control on the optical antenna 16 or a wedge scanner.

The scanner 17 controls an irradiation direction of the transmission light emitted from the optical antenna 16 according to a control signal output from the scanner driver 18 so that an irradiation position of the transmission light with respect to the wind observation region changes with a lapse of time. The irradiation position of the transmission light changes so as to surround the center of the wind observation region.

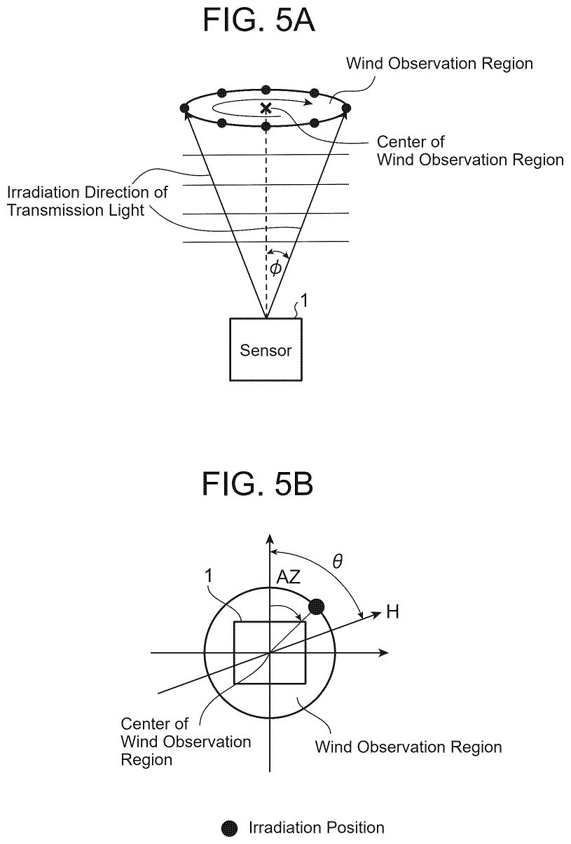

The scanner driver 18 acquires angle information (AZ, φ) related to the irradiation direction of the transmission light from the wind observation device 3. AZ is an azimuth angle and φ is a zenith angle (see FIG. 5).

The scanner driver 18 outputs, to the scanner 17, a control signal for controlling the scanner 17 so that the irradiation direction of the transmission light emitted from the optical antenna 16 is an irradiation direction indicated by the angle information (AZ, φ).

The multiplexing coupler 19 is implemented by, for example, a molten fiber coupler or a filter type coupler using a dielectric multilayer film filter.

The multiplexing coupler 19 multiplexes local light output from the coupler 12 and scattered light output from the optical circulator 15, and outputs the multiplexed light of the local light and the scattered light to the optical receiver 20.

The optical receiver 20 is implemented by, for example, a balanced receiver.

The optical receiver 20 heterodyne-detects the multiplexed light output from the multiplexing coupler 19.

The optical receiver 20 converts an optical signal indicating a detection result of the heterodyne detection into an electrical signal and outputs the electrical signal to the A/D converter 2.

The A/D converter 2 is implemented by, for example, a double integration type A/D converter, a successive comparison type A/D converter, or a parallel comparison type A/D converter.

The A/D converter 2 converts an analog signal, which is the electrical signal output from the optical receiver 20, into a digital signal.

The A/D converter 2 outputs reception data, which is a digital signal, to the wind observation device 3.

In the wind observation system illustrated in FIG. 1, the A/D converter 2 is disposed separately from the sensor 1 and the wind observation device 3. However, this is merely an example, and the A/D converter 2 may be built in either the sensor 1 or the wind observation device 3.

The wind observation device 3 includes a reception signal acquiring unit 31, a signal integration unit 32, and a wind vector selecting unit 33.

The reception signal acquiring unit 31 is implemented by, for example, a reception signal acquiring circuit 41 illustrated in FIG. 2.

The reception signal acquiring unit 31 acquires the reception data output from the A/D converter 2 as a reception signal of scattered light of each laser beam scattered by aerosol present in the wind observation region.

The reception signal acquiring unit 31 outputs the reception data to the signal integration unit 32.

The signal integration unit 32 is implemented by, for example, a signal integration circuit 42 illustrated in FIG. 2.

The signal integration unit 32 includes a first shift processing unit 32a and a first signal integration processing unit 32b.

The signal integration unit 32 shifts a frequency of each reception signal acquired by the reception signal acquiring unit 31 using a frequency shift amount corresponding to each of a plurality of mutually different wind vectors.

The signal integration unit 32 integrates spectra of the plurality of reception signals after the frequency shift for each wind vector.

Each of the plurality of wind vectors includes, as three elements, a wind speed value of horizontal wind H, a wind speed value of vertical wind W, and a wind direction θ. In each wind vector, one or more of the three elements are different from those of the other wind vectors.

The first shift processing unit 32a acquires the reception data as a reception signal of each scattered light beam from the reception signal acquiring unit 31.

The first shift processing unit 32a shifts a frequency of each piece of the reception data using a frequency shift amount corresponding to each of the plurality of wind vectors. The frequency shift performed by the first shift processing unit 32a is a shift in a time domain.

The first shift processing unit 32a outputs each piece of the reception data after the frequency shift for each wind vector to the first signal integration processing unit 32b.

The first signal integration processing unit 32b acquires each piece of the reception data after the frequency shift for each wind vector from the first shift processing unit 32a.

The first signal integration processing unit 32b calculates a spectrum of each piece of the reception data after the frequency shift for each wind vector.

The first signal integration processing unit 32b integrates spectra of the plurality of pieces of reception data for each wind vector.

The first signal integration processing unit 32b outputs the integrated spectrum of the reception data for each wind vector to the wind vector selecting unit 33.

The wind vector selecting unit 33 is implemented by, for example, a wind vector selecting circuit 43 illustrated in FIG. 2.

The wind vector selecting unit 33 acquires the integrated spectrum of the reception data for each wind vector from the signal integration unit 32.

The wind vector selecting unit 33 selects a wind vector corresponding to a wind vector in the wind observation region from among the plurality of wind vectors on the basis of the integrated spectrum of the reception data for each wind vector.

Specifically, the wind vector selecting unit 33 specifies a peak value included in the spectrum integrated by the signal integration unit 32 for each wind vector.

Then, the wind vector selecting unit 33 compares peak values of the plurality of wind vectors with each other.

Then, the wind vector selecting unit 33 selects a wind vector corresponding to a wind vector in the wind observation region from among the plurality of wind vectors on the basis of a comparison result of the peak values.

The wind vector selecting unit 33 outputs the wind vector in the wind observation region to, for example, a display device (not illustrated).

In FIG. 1, it is assumed that each of the reception signal acquiring unit 31, the signal integration unit 32, and the wind vector selecting unit 33, which are components of the wind observation device 3, is implemented by dedicated hardware as illustrated in FIG. 2. That is, it is assumed that the wind observation device 3 is implemented by the reception signal acquiring circuit 41, the signal integration circuit 42, and the wind vector selecting circuit 43.

To each of the reception signal acquiring circuit 41, the signal integration circuit 42, and the wind vector selecting circuit 43, a single circuit, a composite circuit, a programmed processor, a parallel programmed processor, an application specific integrated circuit (ASIC), a field-programmable gate array (FPGA), or a combination thereof corresponds.

The components of the wind observation device 3 are not limited to those implemented by dedicated hardware, and the wind observation device 3 may be implemented by software, firmware, or a combination of software and firmware.

Software or firmware is stored as a program in a memory of a computer. The computer means hardware that executes a program. To the computer, for example, a central processing unit (CPU), a graphics processing unit (GPU), a central processing device, a processing device, an arithmetic device, a microprocessor, a microcomputer, a processor, or a digital signal processor (DSP) corresponds.

FIG. 3 is a hardware configuration diagram of a computer in a case where the wind observation device 3 is implemented by software, firmware, or the like.

When the wind observation device 3 is implemented by software, firmware, or the like, a program for causing the computer to execute processing procedures performed in each of the reception signal acquiring unit 31, the signal integration unit 32, and the wind vector selecting unit 33 is stored in a memory 51. A processor 52 of the computer executes the program stored in the memory 51.

FIG. 2 illustrates an example in which each of the components of the wind observation device 3 is implemented by dedicated hardware, and FIG. 3 illustrates an example in which the wind observation device 3 is implemented by software, firmware, or the like. However, this is merely an example, and some of the components of the wind observation device 3 may be implemented by dedicated hardware, and the remaining components may be implemented by software, firmware, or the like.

Next, an operation of the wind observation system illustrated in FIG. 1 will be described.

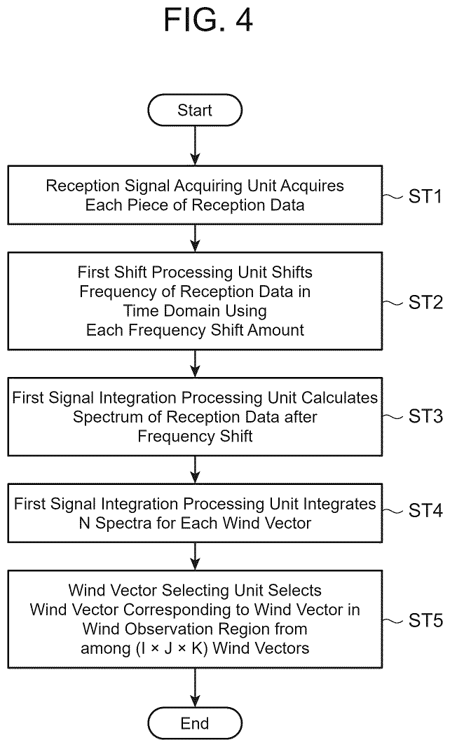

FIG. 4 is a flowchart illustrating a wind observation method which is a processing procedure performed by the wind observation device 3.

The optical oscillator 11 oscillates a laser beam such as pulsed light, and outputs the laser beam to the coupler 12.

The coupler 12 acquires the laser beam from the optical oscillator 11.

The coupler 12 distributes the laser beam into transmission light and local light.

The coupler 12 outputs the transmission light to the optical modulator 13 and outputs the local light to the multiplexing coupler 19.

The optical modulator 13 acquires the transmission light from the coupler 12.

The optical modulator 13 shifts a frequency of the transmission light by performing phase modulation processing or frequency modulation processing on the transmission light.

In addition, the optical modulator 13 performs intensity modulation on the transmission light after the frequency shift at a timing of receiving a trigger signal from the wind observation device 3.

Then, the optical modulator 13 outputs the transmission light after the intensity modulation to the optical amplifier 14.

The optical amplifier 14 amplifies the transmission light output from the optical modulator 13 and outputs the amplified transmission light to the optical circulator 15.

When receiving the transmission light from the optical amplifier 14, the optical circulator 15 outputs the transmission light to the optical antenna 16.

The optical antenna 16 emits the transmission light output from the optical circulator 15.

In the reception signal acquiring unit 31 of the wind observation device 3, a scanning speed of the scanner 17 and a scanning angle range of the scanner 17 are set in advance.

The scanning speed is set by a user within a speed range in which the scanner 17 can perform scanning. The scanning angle range is set by the user within an angle range in which the scanner 17 can perform scanning. For example, 10 [deg/sec] is set as the scanning speed, and for example, 0 to 359 [deg] is set as the scanning angle range.

The reception signal acquiring unit 31 outputs angle information (AZ, φ) related to an irradiation direction of transmission light to the scanner driver 18. The angle information (AZ, φ) is determined by the scanning speed and the scanning angle range.

The scanner driver 18 outputs, to the scanner 17, a control signal for controlling the scanner 17 so that the irradiation direction of the transmission light emitted from the optical antenna 16 is an irradiation direction indicated by the angle information (AZ, φ).

As illustrated in FIG. 5, the scanner 17 controls an irradiation direction of the transmission light emitted from the optical antenna 16 according to a control signal output from the scanner driver 18 so that an irradiation position of the transmission light with respect to the wind observation region surrounds the center of the wind observation region.

FIG. 5 is an explanatory diagram illustrating an irradiation direction of the transmission light emitted from the optical antenna 16.

FIG. 5A is an explanatory diagram illustrating an irradiation direction of the transmission light when each of the sensor 1 and the wind observation region is viewed from a side.

FIG. 5B is an explanatory diagram illustrating an irradiation direction of the transmission light when each of the sensor 1 and the wind observation region is viewed from above.

In FIG. 5, AZ represents an azimuth angle, φ represents a zenith angle, and an irradiation direction of the transmission light is determined by the azimuth angle AZ and the zenith angle φ. θ is a wind direction in the wind observation region.

The wind observation region illustrated in FIG. 5 indicates a wind observation region in any range bin Rb (Rb=1, 2, . . . , RB) among RB range bins described later.

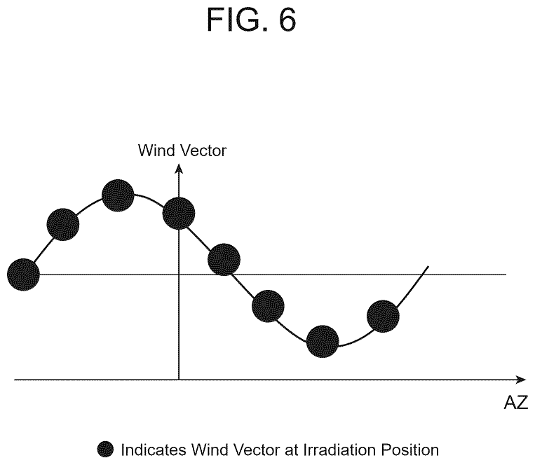

FIG. 6 is an explanatory diagram illustrating a wind vector at an irradiation position of the transmission light.

In FIG. 6, the horizontal axis represents an azimuth angle AZ, and the vertical axis represents a wind vector at an irradiation position of the transmission light. The wind vector includes, as three elements, a wind speed value of horizontal wind H, a wind speed value of vertical wind W, and a wind direction θ. The wind speed value of horizontal wind H is a horizontal component of wind in the wind observation region, and the wind speed value of vertical wind W is a vertical component of wind in the wind observation region.

Since an irradiation direction of the transmission light is controlled so that an irradiation position of the transmission light with respect to the wind observation region surrounds the center of the wind observation region, a plurality of the irradiation positions is generally represented by a waveform of a cosine function.

The optical antenna 16 receives scattered light of the transmission light scattered by aerosol present in the wind observation region.

Specifically, the optical antenna 16 receives scattered light of the transmission light scattered by aerosol at each irradiation position.

The optical antenna 16 outputs each scattered light beam to the optical circulator 15.

When receiving each scattered light beam from the optical antenna 16, the optical circulator 15 outputs each scattered light beam to the multiplexing coupler 19.

The multiplexing coupler 19 multiplexes local light output from the coupler 12 and each scattered light beam output from the optical circulator 15.

The multiplexing coupler 19 outputs the multiplexed light of the local light and each scattered light beam to the optical receiver 20.

The optical receiver 20 acquires each multiplexed light beam from the multiplexing coupler 19.

The optical receiver 20 heterodyne-detects each multiplexed light beam and converts an optical signal indicating a detection result of the heterodyne detection into an electrical signal.

The optical receiver 20 outputs each electrical signal to the A/D converter 2.

The A/D converter 2 acquires each electrical signal from the optical receiver 20.

The A/D converter 2 converts an analog signal, which is each electrical signal, into reception data S(AZ(n)), which is a digital signal. n is a variable indicating the order of transmission light emitted from the sensor 1, and n=1, . . . , N. AZ(n) indicates an azimuth angle related to an irradiation direction of n-th transmission light. N is an integer equal to or more than 1.

In the wind observation system illustrated in FIG. 1, an example in which the zenith angle φ is fixed is illustrated. Therefore, a variable of the zenith angle φ is omitted in the reception data S(AZ(n)). In a case where the zenith angle φ changes, the reception data is expressed as, for example, S(AZ(n), φ(n)).

The A/D converter 2 outputs each piece of reception data S(AZ(n)) to the wind observation device 3.

The reception signal acquiring unit 31 acquires each piece of reception data S(AZ(n)) from the A/D converter 2 (step ST1 in FIG. 4).

The reception signal acquiring unit 31 outputs each piece of reception data S(AZ(n)) to the signal integration unit 32.

The first shift processing unit 32a of the signal integration unit 32 acquires each piece of reception data S(AZ(n)) from the reception signal acquiring unit 31.

In the first shift processing unit 32a, distance resolution is set in advance.

The first shift processing unit 32a divides each piece of reception data S(AZ(n)) into sections having a time width corresponding to the distance resolution. When the distance resolution is, for example, 30 [m], a time width corresponding to the distance resolution is 200 [ns](=2×Rᵣₑₛ/c), and the reception data S(AZ(n)) is divided at intervals of 200 [ns]. c is a speed of light, and Rᵣₑₛ is the distance resolution.

The first shift processing unit 32a stores reception data S(AZ(n), Rb) divided into sections having a time width corresponding to the distance resolution. Rb is a variable indicating a range bin, and Rb=1, 2, . . . , RB. RB is the total number of range bins.

An internal memory of the first shift processing unit 32a stores (I×J×K) wind vectors (H(i), W(j), θ(k)). Each of I, J, and K is an integer of 1 or more. i=1, . . . , I, j=1, . . . , J, and k=1, . . . , K.

H(i) is any wind speed value among I wind speed values from a minimum value Hₘᵢₙ of the wind speed value of horizontal wind H to a maximum value Hₘₐₓ of the wind speed value of horizontal wind H. As the wind speed value H(i) of horizontal wind H, for example, a value in increments of 1 [m/s] in a range of 0 (=minimum value Hₘᵢₙ) [m/s] to 10 (=maximum value Hₘₐₓ) [m/s] can be used.

W(j) is any wind speed value among J wind speed values from a minimum value Wₘᵢₙ of the wind speed value of vertical wind W to a maximum value Wₘₐₓ of the wind speed value of vertical wind W. As the wind speed value W(j) of vertical wind W, for example, a value in increments of 1 [m/s] in a range of −5(=minimum value Wₘᵢₙ) [m/s] to 5(=maximum value Wₘₐₓ) [m/s] can be used.

θ(k) is any wind direction among K wind directions from θₘᵢₙ to θₘₐₓ. As the wind direction θ(k), for example, a value in increments of 1 [deg] in a range of 0 (=θₘᵢₙ) [deg] to 359(=θₘₐₓ) [deg] can be used.

The first shift processing unit 32a calculates a frequency shift amount f_{d}(H(i), W(j), θ(k), AZ(n), Rb) corresponding to a wind vector (H(i), W(j), θ(k)) (i=1, . . . , I; j=1, . . . , J; and k=1, . . . , K) for each range bin Rb (Rb=1, 2, . . . , RB) as expressed in the following equation (1).

$${f}_{d} ( H ( i ) , W ( j ) , θ ( k ) , AZ ( n ) , R b ) = \frac{2}{λ} \times \frac{H ( i ) cos ( A Z ( n ) + θ ( k ) )}{sin ϕ} + \frac{W ( j )}{cos ϕ} \qquad ( 1 )$$

In equation (1), λ represents a wavelength of transmission light.

The first shift processing unit 32a shifts a frequency of reception data S(AZ(n), Rb) in a time domain using each frequency shift amount f_{d}(H(i), W(j), θ(k), AZ(n), Rb) (i=1, . . . , I; j=1, . . . , J; and k=1, . . . , K) for each range bin Rb (Rb=1, 2, . . . , RB) as expressed in the following equation (2) (step ST2 in FIG. 4).

The first shift processing unit 32a outputs reception data Sᵣₑᵥ(H(i), W(j), θ(k), n, Rb) (i=1, . . . , I; j=1, . . . , J; and k=1, . . . , K) after the frequency shift for each range bin Rb (Rb=1, 2, . . . , RB) to the first signal integration processing unit 32b.

$${S}_{rev} ( H ( i ) , W ( j ) , θ ( k ) , n , Rb ) = S ( A Z ( n ) , Rb ) \times exp ( - j 2 π {f}_{d} ( H ( i ) , W ( j ) , θ ( k ) , AZ ( n ) , Rb ) ) \qquad ( 2 )$$

The first signal integration processing unit 32b acquires the reception data Sᵣₑᵥ(H(i), W(j), θ(k), n, Rb) (i=1, . . . , I; j=1, . . . , J; and k=1, . . . , K) after the frequency shift for each range bin Rb (Rb=1, 2, . . . , RB) from the first shift processing unit 32a.

The first signal integration processing unit 32b calculates a spectrum SPC(H(i), W(j), θ(k), n, Rb) of the reception data Sᵣₑᵥ(H(i), W(j), θ(k), n, Rb) after the frequency shift by performing fast Fourier transform (FFT) on the reception data Sᵣₑᵥ(H(i), W(j), θ(k), n, Rb) after the frequency shift as expressed in the following equation (3) (step ST3 in FIG. 4).

$$S P C ( H ( i ) , W ( j ) , θ ( k ) , n , Rb ) = F F T ( {S}_{r e v} ( H ( i ) , W ( j ) , θ ( k ) , n , Rb ) ) \qquad ( 3 )$$

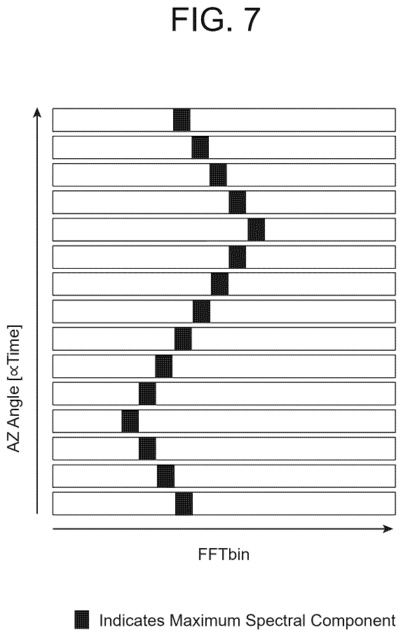

FIG. 7 is an explanatory diagram illustrating a spectrum of reception data S(AZ(n), Rb) whose frequency is not shifted by the first shift processing unit 32a. An FFT bin on the horizontal axis in FIG. 7 corresponds to a distance bin.

In a case where the sensor 1 is a conical scanning sensor, a distance bin corresponding to a maximum spectral component among a plurality of spectral components included in reception data S(AZ(n), Rb) corresponding to each azimuth angle AZ is generally represented by a waveform of a cosine function.

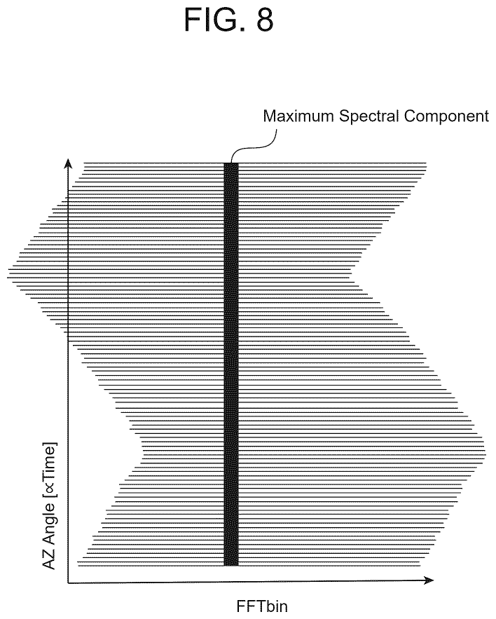

FIG. 8 is an explanatory diagram illustrating a spectrum SPC(H(i), W(j), θ(k), n, Rb) of the reception data Sᵣₑᵥ(H(i), W(j), θ(k), n, Rb) after the frequency shift performed by the first shift processing unit 32a. An FFT bin on the horizontal axis in FIG. 8 corresponds to a distance bin.

Even in a case where the sensor 1 is a conical scanning sensor, when each of H(i), W(j), and θ(k) in the spectrum SPC (H(i), W(j), θ(k), n, Rb) is close to three elements included in a wind vector corresponding to a wind vector in the wind observation region, a distance bin corresponding to a maximum spectral component hardly changes.

The first signal integration processing unit 32b integrates N spectra SPC(H(i), W(j), θ(k), l, Rb) to SPC (H(i), W(j), θ(k), N, Rb) for each wind vector (H(i), W(j), θ(k)) for each range bin Rb (Rb=1, 2, . . . , RB) as expressed in the following equation (4) (step ST4 in FIG. 4).

The first signal integration processing unit 32b outputs an integrated spectrum SPCᵢₙₜ(H(i), W(j), θ(k), Rb) for each range bin Rb (Rb=1, 2, . . . , RB) to the wind vector selecting unit 33.

$$S P {C}_{int} ( H ( i ) , W ( j ) , θ ( k ) , Rb ) = {\sum }_{n = 1}^{N} SPC ( H ( i ) , W ( j ) , θ ( k ) , n , Rb ) \qquad ( 4 )$$

The wind vector selecting unit 33 acquires the integrated spectrum SPCᵢₙₜ(H(i), W(j), θ(k), Rb) for each range bin Rb (Rb=1, 2, . . . , RB) from the first signal integration processing unit 32b.

The wind vector selecting unit 33 extracts a maximum spectral component as a peak value P(H(i), W(j), θ(k), Rb) from among a plurality of spectral components included in the integrated SPCᵢₙₜ(H(i), W(j), θ(k), Rb) for each range bin Rb (Rb=1, 2, . . . , RB).

The wind vector selecting unit 33 specifies a maximum peak value Pₘₐₓ(Rb) among (I×J×K) peak values P(H(i), W(j), θ(k), Rb) by comparing (I×J×K) peak values P(H(i), W(j), θ(k), Rb) with each other for each range bin Rb (Rb=1, 2, . . . , RB).

The wind vector selecting unit 33 selects a wind vector corresponding to the maximum peak value Pₘₐₓ(Rb) as a wind vector (H, W, θ) corresponding to a wind vector in the wind observation region from among (I×J×K) wind vectors (H(i), W(j), θ(k)) (step ST5 in FIG. 4).

The wind vector corresponding to the maximum peak value Pₘₐₓ(Rb) is a wind vector (H(i), W(j), θ(k)) related to the integrated spectrum SPCᵢₙₜ(H(i), W(j), θ(k), Rb) including the maximum peak value Pₘₐₓ(Rb).

That is, the wind vector corresponding to the maximum peak value Pₘₐₓ(Rb) is a wind vector (H(i), W(j), θ(k)) corresponding to the frequency shift amount fa (H(i), W(j), θ(k), AZ(n), Rb) used for calculating the integrated spectrum SPCᵢₙₜ(H(i), W(j), θ(k), Rb) including the maximum peak value Pₘₐₓ(Rb).

The wind vector selecting unit 33 compares the maximum peak value Pₘₐₓ(Rb) with a threshold Th. The threshold Th may be stored in an internal memory of the wind vector selecting unit 33 or may be given from the outside of the wind observation device 3. As the threshold Th, for example, a maximum noise amount in the wind observation system or a value obtained by adding a margin to the maximum noise amount can be used. The threshold Th may be, for example, a maximum peak value Pₘₐₓ(Rb) specified when the optical amplifier 14 is OFF.

When the maximum peak value Pₘₐₓ(Rb) is larger than the threshold Th, the wind vector selecting unit 33 outputs a wind vector corresponding to the maximum peak value Pₘₐₓ(Rb) to, for example, a display device (not illustrated).

Specifically, the wind vector selecting unit 33 outputs the wind speed value of horizontal wind H, the wind speed value of vertical wind W, and the wind direction θ as three elements included in the wind vector corresponding to the maximum peak value Pₘₐₓ(Rb) to, for example, a display device (not illustrated).

When the maximum peak value Pₘₐₓ(Rb) is equal to or less than the threshold Th, the wind vector selecting unit 33 determines that the wind vector corresponding to the maximum peak value Pₘₐₓ(Rb) is not an appropriate wind vector, and does not output the wind vector.

In the wind observation device 3 illustrated in FIG. 1, only when the maximum peak value Pₘₐₓ(Rb) is larger than the threshold Th, the wind vector selecting unit 33 outputs the wind vector corresponding to the maximum peak value Pₘₐₓ(Rb). However, this is merely an example, and regardless of whether or not the maximum peak value Pₘₐₓ(Rb) is larger than the threshold Th, the wind vector selecting unit 33 may output the wind vector corresponding to the maximum peak value Pₘₐₓ(Rb).

In the wind observation device 3 illustrated in FIG. 1, the wind vector selecting unit 33 outputs the wind vector corresponding to the maximum peak value Pₘₐₓ(Rb) to a display device (not illustrated). The output destination of the wind vector corresponding to the maximum peak value Pₘₐₓ(Rb) is not limited to the display device, and for example, the wind vector may be output to a weather observation site (not illustrated).

In the first embodiment described above, the wind observation device 3 is configured in such a manner as to include: the reception signal acquiring unit 31 that acquires a reception signal of each scattered light beam from the conical scanning sensor 1 that repeatedly emits a laser beam toward a wind observation region and receives scattered light of each laser beam scattered by aerosol present in the wind observation region; and the signal integration unit 32 that shifts a frequency of each reception signal acquired by the reception signal acquiring unit 31 using a frequency shift amount corresponding to each of a plurality of mutually different wind vectors and integrates spectra of the plurality of reception signals after the frequency shift for each wind vector. In addition, the wind observation device 3 includes the wind vector selecting unit 33 that selects a wind vector corresponding to a wind vector in the wind observation region from among the plurality of wind vectors on the basis of the spectrum of the reception signals integrated by the signal integration unit 32 for each wind vector. Therefore, the wind observation device 3 can prevent deterioration of calculation accuracy of a wind vector by increasing an SNR of a reception signal as compared with that of the wind observation device disclosed in Non-Patent Literature 1.

### Second Embodiment

In a second embodiment, a wind observation device 3 in which a signal integration unit 34 includes a second shift processing unit 34a that calculates a spectrum of each reception signal acquired by a reception signal acquiring unit 31 and shifts a frequency of a spectrum of each reception signal using a frequency shift amount corresponding to each wind vector will be described.

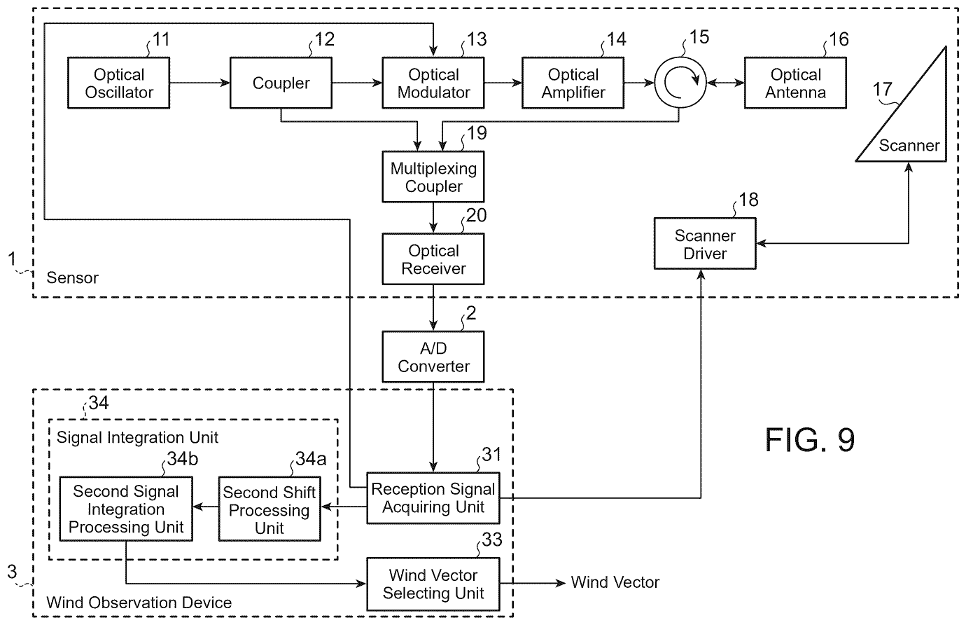

FIG. 9 is a configuration diagram illustrating a wind observation system including the wind observation device 3 according to the second embodiment. In FIG. 9, the same reference numerals as in FIG. 1 indicate the same or corresponding parts, and therefore detailed description thereof is omitted.

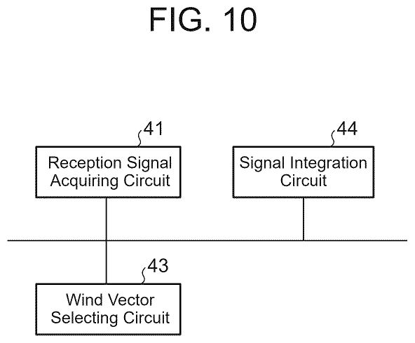

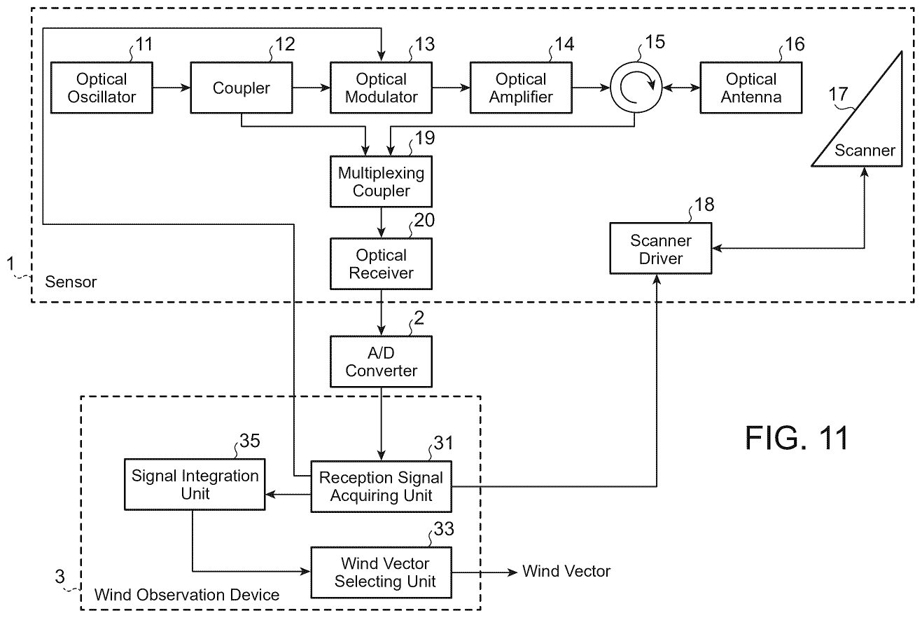

FIG. 10 is a hardware configuration diagram illustrating hardware of the wind observation device 3 according to the second embodiment. In FIG. 10, the same reference numerals as in FIG. 2 indicate the same or corresponding parts, and therefore detailed description thereof is omitted.

The wind observation system illustrated in FIG. 9 includes a sensor 1, an A/D converter 2, and the wind observation device 3.

The wind observation device 3 includes the reception signal acquiring unit 31, the signal integration unit 34, and a wind vector selecting unit 33.

The signal integration unit 34 is implemented by, for example, a signal integration circuit 44 illustrated in FIG. 10.

The signal integration unit 34 includes the second shift processing unit 34a and a second signal integration processing unit 34b.

The signal integration unit 34 shifts a frequency of each reception signal acquired by the reception signal acquiring unit 31 using a frequency shift amount corresponding to each of a plurality of mutually different wind vectors and integrates spectra of the plurality of reception signals after the frequency shift for each wind vector.

The second shift processing unit 34a acquires reception data as a reception signal of scattered light of each laser beam from the reception signal acquiring unit 31.

The second shift processing unit 34a calculates a spectrum of each piece of the reception data by performing FFT on each piece of the reception data.

The second shift processing unit 34a shifts a frequency of the spectrum of each piece of the reception data using a frequency shift amount corresponding to each wind vector. The frequency shift performed by the second shift processing unit 34a is a shift in a frequency domain.

The second shift processing unit 34a outputs each spectrum after the frequency shift for each wind vector to the second signal integration processing unit 34b.

The second signal integration processing unit 34b acquires each spectrum after the frequency shift for each wind vector from the second shift processing unit 34a.

The second signal integration processing unit 34b integrates a plurality of spectra for each wind vector.

The second signal integration processing unit 34b outputs the integrated spectrum for each wind vector to the wind vector selecting unit 33.

In FIG. 9, it is assumed that each of the reception signal acquiring unit 31, the signal integration unit 34, and the wind vector selecting unit 33, which are components of the wind observation device 3, is implemented by dedicated hardware as illustrated in FIG. 10. That is, it is assumed that the wind observation device 3 is implemented by the reception signal acquiring circuit 41, the signal integration circuit 44, and the wind vector selecting circuit 43.

To each of the reception signal acquiring circuit 41, the signal integration circuit 44, and the wind vector selecting circuit 43, for example, a single circuit, a composite circuit, a programmed processor, a parallel programmed processor, an ASIC, a FPGA, or a combination thereof corresponds.

The components of the wind observation device 3 are not limited to those implemented by dedicated hardware, and the wind observation device 3 may be implemented by software, firmware, or a combination of software and firmware.

When the wind observation device 3 is implemented by software, firmware, or the like, a program for causing a computer to execute processing procedures performed in each of the reception signal acquiring unit 31, the signal integration unit 34, and the wind vector selecting unit 33 is stored in the memory 51 illustrated in FIG. 3. Then, the processor 52 illustrated in FIG. 3 executes the program stored in the memory 51.

FIG. 10 illustrates an example in which each of the components of the wind observation device 3 is implemented by dedicated hardware, and FIG. 3 illustrates an example in which the wind observation device 3 is implemented by software, firmware, or the like. However, this is merely an example, and some of the components of the wind observation device 3 may be implemented by dedicated hardware, and the remaining components may be implemented by software, firmware, or the like.

Next, an operation of the wind observation system illustrated in FIG. 9 will be described. Note that the wind observation system is similar to the wind observation system illustrated in FIG. 1 except for the signal integration unit 34. Therefore, only an operation of the signal integration unit 34 will be described here.

The second shift processing unit 34a of the signal integration unit 34 acquires each piece of reception data S(AZ(n)) from the reception signal acquiring unit 31.

In the second shift processing unit 34a, distance resolution is set in advance.

Similarly to the first shift processing unit 32a illustrated in FIG. 1, the second shift processing unit 34a divides each piece of reception data S(AZ(n)) into sections having a time width corresponding to the distance resolution.

The second shift processing unit 34a stores reception data S(AZ(n), Rb) divided into sections having a time width corresponding to the distance resolution.

An internal memory of the second shift processing unit 34a stores (I×J×K) wind vectors (H(i), W(j), θ(k)).

Similarly to the first shift processing unit 32a illustrated in FIG. 1, the second shift processing unit 34a calculates a frequency shift amount fa (H(i), W(j), θ(k), AZ(n), Rb) corresponding to a wind vector (H(i), W(j), θ(k)) (i=1, . . . , I; j=1, . . . , J; and k=1, . . . , K) for each range bin Rb (Rb=1, 2, . . . , RB).

The second shift processing unit 34a calculates a spectrum SPC(AZ(n), Rb) of each piece of reception data S(AZ(n), Rb) by performing FFT on each piece of reception data S(AZ(n), Rb) as expressed by the following equation (5).

$$S P C ( A Z ( n ) , Rb ) = F F T ( S ( A Z ( n ) ) \qquad ( 5 )$$

The second shift processing unit 34a calculates a bin shift amount Bin_{shift}(H(i), W(j), θ(k), AZ(n), Rb) for shifting a frequency bin of the spectrum SPC (AZ(n), Rb) on the basis of the frequency shift amount f_{d}(H(i), W(j), θ(k), AZ(n), Rb) (i=1, . . . , I; j=1, . . . , J; and k=1, . . . , K) for each range bin Rb (Rb=1, 2, . . . , RB) as expressed in the following equation (6).

$${Bin}_{shift} ( H ( i ) , W ( j ) , θ ( k ) , AZ ( n ) , Rb ) = - \frac{{f}_{d} ( H ( i ) , W ( j ) , θ ( k ) , AZ ( n ) , Rb )}{df} \qquad ( 6 )$$

In equation (6), df is frequency resolution.

The second shift processing unit 34a shifts a frequency bin of the spectrum SPC(AZ(n), Rb) using a bin shift amount Bin_{shift}(H(i), W(j), θ(k), AZ(n)) (i=1, . . . , I; j=1, . . . , J; and k=1, . . . , K) corresponding to the frequency shift amount f_{d}(H(i), W(j), θ(k), AZ(n), Rb) for each range bin Rb (Rb=1, 2, . . . , RB).

Note that, when the number of spectral points of the spectrum SPC(AZ(n), Rb) is M and the frequency bin is shifted in a positive direction by, for example, a point G, the second shift processing unit 34a shifts the frequency bin of the spectrum SPC(AZ(n), Rb) by the point G and then fills “0” in first to Gth frequency bins.

The second shift processing unit 34a outputs each spectrum SPC′(H(i), W(j), θ(k), n, Rb (i=1, . . . , I; j=1, . . . , J; and k=1, . . . , K) after the frequency bin shift for each range bin Rb (Rb=1, 2, . . . , RB) to the second signal integration processing unit 34b.

The second signal integration processing unit 34b acquires each spectrum SPC′(H(i), W(j), θ(k), n, Rb (i=1, . . . , I; j=1, . . . , J; and k=1, . . . , K) after the frequency shift for each range bin Rb (Rb=1, 2, . . . , RB) from the second shift processing unit 34a.

The second signal integration processing unit 34b integrates N spectra SPC′(H(i), W(j), θ(k), l, Rb) to SPC′(H(i), W(j), θ(k), N, Rb) for each wind vector (H(i), W(j), θ(k)) for each range bin Rb (Rb=1, 2, . . . , RB) as expressed in the following equation (7).

The second signal integration processing unit 34b outputs an integrated spectrum SPCᵢₙₜ(H(i), W(j), θ(k), Rb) for each range bin Rb (Rb=1, 2, . . . , RB) to the wind vector selecting unit 33.

$$SP {C}_{int} ( H ( i ) , W ( j ) , θ ( k ) , Rb ) = {\sum }_{n = 1}^{N} {SPC}^{′} ( H ( i ) , W ( j ) , θ ( k ) , n , Rb ) \qquad ( 7 )$$

In the second embodiment described above, the wind observation device 3 is configured in such a manner that the signal integration unit 34 includes the second shift processing unit 34a that calculates a spectrum of each reception signal acquired by the reception signal acquiring unit 31 and shifts a frequency of a spectrum of each reception signal using a frequency shift amount corresponding to each wind vector, and the second signal integration processing unit 34b that integrates a plurality of spectra after the frequency shift performed by the second shift processing unit 34a for each wind vector. Therefore, the wind observation device 3 can prevent deterioration of calculation accuracy of a wind vector by increasing an SNR of a reception signal as compared with that of the wind observation device disclosed in Non-Patent Literature 1.

### Third Embodiment

In a third embodiment, a wind observation device 3 in which a signal integration unit 35 integrates spectra of a plurality of reception signals after frequency shift, and corrects the integrated spectrum of the reception signals using a spectrum of a reception signal when there is no noise floor will be described.

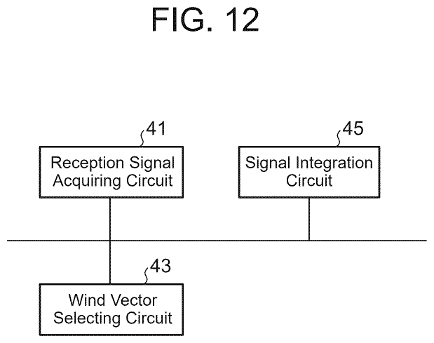

FIG. 11 is a configuration diagram illustrating a wind observation system including the wind observation device 3 according to the third embodiment. In FIG. 11, the same reference numerals as in FIGS. 1 and 9 indicate the same or corresponding parts, and therefore detailed description thereof is omitted.

FIG. 12 is a hardware configuration diagram illustrating hardware of the wind observation device 3 according to the third embodiment. In FIG. 12, the same reference numerals as in FIGS. 2 and 10 indicate the same or corresponding parts, and therefore detailed description thereof is omitted.

The wind observation system illustrated in FIG. 11 includes a sensor 1, an A/D converter 2, and the wind observation device 3.

The wind observation device 3 includes a reception signal acquiring unit 31, the signal integration unit 35, and a wind vector selecting unit 33.

The signal integration unit 35 is implemented by, for example, a signal integration circuit 45 illustrated in FIG. 12.

Similarly to either the signal integration unit 32 illustrated in FIG. 1 or the signal integration unit 34 illustrated in FIG. 9, the signal integration unit 35 shifts a frequency of each reception signal acquired by the reception signal acquiring unit 31 using a frequency shift amount corresponding to each of a plurality of mutually different wind vectors and integrates spectra of the plurality of reception signals after the frequency shift for each wind vector.

In addition, the signal integration unit 35 corrects the integrated spectrum of reception signals using a spectrum of a reception signal when there is no noise floor.

The signal integration unit 35 outputs the corrected spectrum to the wind vector selecting unit 33.

In FIG. 11, it is assumed that each of the reception signal acquiring unit 31, the signal integration unit 35, and the wind vector selecting unit 33, which are components of the wind observation device 3, is implemented by dedicated hardware as illustrated in FIG. 12. That is, it is assumed that the wind observation device 3 is implemented by the reception signal acquiring circuit 41, the signal integration circuit 45, and the wind vector selecting circuit 43.

To each of the reception signal acquiring circuit 41, the signal integration circuit 45, and the wind vector selecting circuit 43, for example, a single circuit, a composite circuit, a programmed processor, a parallel programmed processor, an ASIC, a FPGA, or a combination thereof corresponds.

The components of the wind observation device 3 are not limited to those implemented by dedicated hardware, and the wind observation device 3 may be implemented by software, firmware, or a combination of software and firmware.

When the wind observation device 3 is implemented by software, firmware, or the like, a program for causing a computer to execute processing procedures performed in each of the reception signal acquiring unit 31, the signal integration unit 35, and the wind vector selecting unit 33 is stored in the memory 51 illustrated in FIG. 3. Then, the processor 52 illustrated in FIG. 3 executes the program stored in the memory 51.

FIG. 12 illustrates an example in which each of the components of the wind observation device 3 is implemented by dedicated hardware, and FIG. 3 illustrates an example in which the wind observation device 3 is implemented by software, firmware, or the like. However, this is merely an example, and some of the components of the wind observation device 3 may be implemented by dedicated hardware, and the remaining components may be implemented by software, firmware, or the like.

Next, an operation of the wind observation system illustrated in FIG. 11 will be described. Note that the wind observation system is similar to the wind observation system illustrated in FIG. 1 or the wind observation system illustrated in FIG. 9 except for the signal integration unit 35. Therefore, only an operation of the signal integration unit 35 will be described here.

Similarly to the signal integration unit 32 illustrated in FIG. 1, the signal integration unit 35 calculates an integrated spectrum SPCᵢₙₜ(H(i), W(j), θ(k), Rb) by integrating N spectra SPC(H(i), W(j), θ(k), l, Rb) to SPC(H(i), W(j), θ(k), N, Rb) for each wind vector (H(i), W(j), θ(k)).

In addition, the signal integration unit 35 acquires reception data Sₙₒᵢₛₑ(j, Rb) output from the reception signal acquiring unit 31, for example, when the optical amplifier 14 is OFF or when the optical antenna 16 is shielded from light, as reception data S (j, Rb) when there is no noise floor. The noise floor includes, for example, colored noise.

The signal integration unit 35 calculates a noise spectrum SPCₙₒᵢₛₑ(N_{fl}, Rb) corresponding to power of the noise floor by performing FFT on the reception data Sₙₒᵢₛₑ(j, Rb) as expressed in the following equation (8). Na is the number of shots when the noise spectrum is acquired. N_{fl} is set to such a value that the noise spectrum SPCₙₒᵢₛₑ(N_{fl}, Rb) is only an offset component of the reception data S(AZ(n), Rb) by suppressing noise variation. For example, N_{fl}=100,000.

$${SPC}_{noise} ( {N}_{fl} , Rb ) = \frac{1}{{N}_{fl}} {\sum }_{j = 1}^{{N}_{fl}} FFT ( {S}_{n o i s e} ( j , Rb ) ) \qquad ( 8 )$$

The signal integration unit 35 removes an influence of the noise floor by dividing the integrated spectrum SPCᵢₙₜ(H(i), W(j), θ(k), Rb) by the noise spectrum SPCₙₒᵢₛₑ(N_{fl}, Rb) as expressed in the following equation (9).

The signal integration unit 35 outputs SPCᵢₙₜ′(H(i), W(j), θ(k), Rb) to the wind vector selecting unit 33 as the integrated spectrum SPCᵢₙₜ(H(i), W(j), θ(k), Rb).

$${SPC}_{int}^{′} ( H ( i ) , W ( j ) , θ ( k ) , R b ) = \frac{S P {C}_{i n t} ( H ( i ) , W ( j ) , θ ( k ) , Rb )}{S P {C}_{noise} ( {N}_{fl} , Rb )} \qquad ( 9 )$$

Here, the signal integration unit 35 removes the influence of the noise floor by dividing the spectrum SPCᵢₙₜ(H(i), W(j), θ(k), Rb) calculated by the equation (4) by the spectrum SPCₙₒᵢₛₑ(N_{fl}, Rb). However, this is merely an example, and the signal integration unit 35 may remove the influence of the noise floor by dividing the spectrum SPCᵢₙₜ(H(i), W(j), θ(k), Rb) calculated by the equation (7) by the noise spectrum SPCₙₒᵢₛₑ(N_{fl}, Rb).

In the third embodiment described above, the wind observation device 3 is configured in such a manner that the signal integration unit 35 integrates spectra of a plurality of reception signals after frequency shift, and corrects the integrated spectrum of the reception signals using a spectrum of a reception signal when there is no noise floor. Therefore, the wind observation device 3 can prevent deterioration of calculation accuracy of a wind vector by increasing an SNR of a reception signal as compared with that of the wind observation device disclosed in Non-Patent Literature 1, and can also increase calculation accuracy of the wind vector by removing an influence of a noise floor.

### Fourth Embodiment

In a fourth embodiment, a wind observation device 3 in which a signal integration unit 36 sets a plurality of wind vectors on the basis of a wind vector previously selected by a wind vector selecting unit 33 will be described.

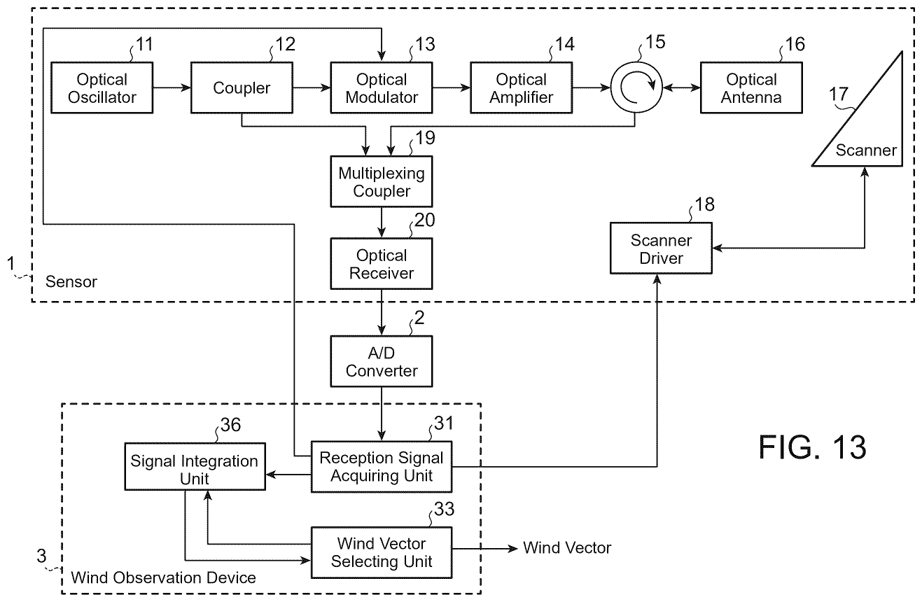

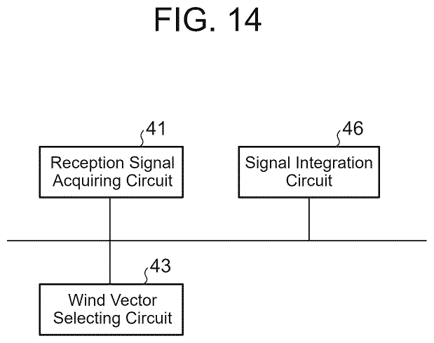

FIG. 13 is a configuration diagram illustrating a wind observation system including the wind observation device 3 according to the fourth embodiment. In FIG. 13, the same reference numerals as in FIGS. 1, 9, and 11 indicate the same or corresponding parts, and therefore detailed description thereof is omitted.

FIG. 14 is a hardware configuration diagram illustrating hardware of the wind observation device 3 according to the fourth embodiment. In FIG. 14, the same reference numerals as in FIGS. 2, 10, and 12 indicate the same or corresponding parts, and therefore detailed description thereof is omitted.

The wind observation system illustrated in FIG. 13 includes a sensor 1, an A/D converter 2, and the wind observation device 3.

The wind observation device 3 includes a reception signal acquiring unit 31, the signal integration unit 36, and the wind vector selecting unit 33.

The signal integration unit 36 is implemented by, for example, a signal integration circuit 46 illustrated in FIG. 14.

Similarly to any one of the signal integration unit 32 illustrated in FIG. 1, the signal integration unit 34 illustrated in FIG. 9, and the signal integration unit 35 illustrated in FIG. 11, the signal integration unit 36 integrates spectra of a plurality of reception signals after frequency shift for each wind vector.

Note that, unlike the signal integration units 32, 34, and 35, the signal integration unit 36 sets (I′×J′×K′) wind vectors (H(i), W(j), θ(k)) on the basis of a wind vector previously selected by the wind vector selecting unit 33. 1≤I′≤I, 1≤J′≤J, and 1≤K′≤K.

The signal integration unit 36 shifts a frequency of each reception signal acquired by the reception signal acquiring unit 31 using a frequency shift amount corresponding to each of (I′×J′×K′) wind vectors (H(i), W(j), θ(k)) and integrates spectra of the plurality of reception signals after the frequency shift for each wind vector.

In FIG. 13, it is assumed that each of the reception signal acquiring unit 31, the signal integration unit 36, and the wind vector selecting unit 33, which are components of the wind observation device 3, is implemented by dedicated hardware as illustrated in FIG. 14. That is, it is assumed that the wind observation device 3 is implemented by the reception signal acquiring circuit 41, the signal integration circuit 46, and the wind vector selecting circuit 43.

To each of the reception signal acquiring circuit 41, the signal integration circuit 46, and the wind vector selecting circuit 43, for example, a single circuit, a composite circuit, a programmed processor, a parallel programmed processor, an ASIC, a FPGA, or a combination thereof corresponds.

The components of the wind observation device 3 are not limited to those implemented by dedicated hardware, and the wind observation device 3 may be implemented by software, firmware, or a combination of software and firmware.

When the wind observation device 3 is implemented by software, firmware, or the like, a program for causing a computer to execute processing procedures performed in each of the reception signal acquiring unit 31, the signal integration unit 36, and the wind vector selecting unit 33 is stored in the memory 51 illustrated in FIG. 3. Then, the processor 52 illustrated in FIG. 3 executes the program stored in the memory 51.

FIG. 14 illustrates an example in which each of the components of the wind observation device 3 is implemented by dedicated hardware, and FIG. 3 illustrates an example in which the wind observation device 3 is implemented by software, firmware, or the like. However, this is merely an example, and some of the components of the wind observation device 3 may be implemented by dedicated hardware, and the remaining components may be implemented by software, firmware, or the like.

Next, an operation of the wind observation system illustrated in FIG. 13 will be described. Note that the wind observation system is similar to the wind observation system illustrated in FIG. 1, the wind observation system illustrated in FIG. 9, or the wind observation system illustrated in FIG. 11 except for the signal integration unit 36. Therefore, only an operation of the signal integration unit 36 will be described here.

First wind observation processing in the wind observation system illustrated in FIG. 13 is similar to first wind observation processing in the wind observation system illustrated in FIG. 1, the wind observation system illustrated in FIG. 9, or the wind observation system illustrated in FIG. 11.

In second and subsequent wind observation processing in the wind observation system illustrated in FIG. 13, the signal integration unit 36 acquires, as a previous observation result, a wind vector corresponding to a maximum peak value Pₘₐₓ(Rb) previously selected by the wind vector selecting unit 33.

The signal integration unit 36 sets (I′×J′×K′) wind vectors (H(i), W(j), θ(k)) on the basis of the wind vector corresponding to the maximum peak value Pₘₐₓ(Rb).

Specifically, the signal integration unit 36 sets a wind speed value of ±□□ of a reference wind speed value to H(i) using a wind speed value of horizontal wind H included in the wind vector corresponding to the maximum peak value Pₘₐₓ(Rb) as a reference. When the wind speed value of horizontal wind H included in the wind vector corresponding to the maximum peak value Pₘₐₓ(Rb) is, for example, 6 [m/s] and □□ is 2 [m/s], the signal integration unit 36 sets 4, 5, 6, 7, or 8 [m/s] to H(i). In this example, I′=5.

The signal integration unit 36 sets a wind speed value of ±ΔΔ of a reference wind speed value to W(j) using a wind speed value of vertical wind W included in the wind vector corresponding to the maximum peak value Pₘₐₓ(Rb) as a reference. When the wind speed value of vertical wind W included in the wind vector corresponding to the maximum peak value Pₘₐₓ(Rb) is, for example, 3 [m/s] and AA is 1 [m/s], the signal integration unit 36 sets 2, 3, or 4 [m/s] to W(j). In this example, J′=3.

The signal integration unit 36 sets a wind direction of ±◯◯ of a reference wind direction θ to θ(k) using a wind direction θ included in the wind vector corresponding to the maximum peak value Pₘₐₓ(Rb) as a reference. When the wind direction θ included in the wind vector corresponding to the maximum peak value Pₘₐₓ(Rb) is, for example, 240 [deg] and ◯◯ is 90 [deg], the signal integration unit 36 sets a value in increments of 5 [deg] to θ(k) in a range of 150 to 330 [deg]. In this example, K′=37.

The signal integration unit 36 shifts a frequency of each reception signal acquired by the reception signal acquiring unit 31 using a frequency shift amount corresponding to each of (I′×J′×K′) wind vectors (H(i), W(j), θ(k)) and integrates spectra of the plurality of reception signals after the frequency shift for each wind vector.

Since the spectrum integrating processing itself performed by the signal integration unit 36 is similar to any one of the spectrum integrating processing performed by the signal integration unit 32 illustrated in FIG. 1, the spectrum integrating processing performed by the signal integration unit 34 illustrated in FIG. 9, and the spectrum integrating processing performed by the signal integration unit 35 illustrated in FIG. 11, detailed description thereof is omitted.

In the fourth embodiment described above, the signal integration unit 36 sets a plurality of wind vectors on the basis of a wind vector previously selected by the wind vector selecting unit 33. The wind observation device 3 illustrated in FIG. 13 is configured in such a manner that the signal integration unit 36 shifts a frequency of each reception signal acquired by the reception signal acquiring unit 31 using a frequency shift amount corresponding to each of the plurality of set wind vectors and integrates spectra of the plurality of reception signals after the frequency shift for each wind vector. Therefore, similarly to the wind observation device 3 illustrated in FIG. 1, the wind observation device 3 illustrated in FIG. 13 can prevent deterioration of calculation accuracy of a wind vector by increasing an SNR of a reception signal as compared with that of the wind observation device disclosed in Non-Patent Literature 1, and can also decrease a processing load as compared with that of the wind observation device 3 illustrated in FIG. 1.

In the first to fourth embodiments, each of the signal integration units 32, 34, 35, and 36 calculates all frequency shift amounts corresponding to each of a plurality of mutually different wind vectors before shifting a frequency of each piece of reception data acquired by the reception signal acquiring unit 31. Then, the signal integration unit 32 or the like shifts a frequency of each piece of reception data using each frequency shift amount and integrates spectra of the plurality of pieces of reception data after the frequency shift for each wind vector.

However, this is merely an example, and the signal integration unit 32 or the like may first calculate a frequency shift amount corresponding to each of any two wind vectors among the plurality of wind vectors, shift a frequency of each piece of reception data using each frequency shift amount, and integrate spectra of the plurality of pieces of reception data after the frequency shift for each wind vector. In this case, the wind vector selecting unit 33 searches for a wind vector corresponding to the maximum peak value Pₘₐₓ(Rb) on the basis of the integrated spectrum of the reception data for each of the two wind vectors. The processing of searching for a wind vector corresponding to the maximum peak value Pₘₐₓ(Rb) is processing of extracting a maximum spectral component as a peak value from among a plurality of spectral components included in each integrated spectrum, and searching for a peak value that becomes a local maximum value among the plurality of extracted peak values. Usually, when the number of wind vectors is only two, it is not possible to search for a peak value that becomes a local maximum value.

When the wind vector selecting unit 33 has not searched for a wind vector corresponding to the maximum peak value Pₘₐₓ(Rb), the signal integration unit 32 or the like calculates a frequency shift amount corresponding to a wind vector that has not been used yet among the plurality of wind vectors, shifts a frequency of reception data using the frequency shift amount, and integrates spectra of the plurality of pieces of reception data after the frequency shift. The wind vector selecting unit 33 searches for a wind vector corresponding to the maximum peak value Pₘₐₓ(Rb) on the basis of the integrated spectrum of the reception data for each of three wind vectors.

The signal integration unit 32 or the like and the wind vector selecting unit 33 repeatedly perform similar processing until the wind vector corresponding to the maximum peak value Pₘₐₓ(Rb) can be searched for.

When the wind vector corresponding to the maximum peak value Pₘₐₓ(Rb) can be searched for, the wind vector selecting unit 33 selects the wind vector as a wind vector corresponding to a wind vector in a wind observation region.

Note that the present disclosure can freely combine the embodiments to each other, modify any component in each of the embodiments, or omit any component in each of the embodiments.

### INDUSTRIAL APPLICABILITY

The present disclosure is suitable for a wind observation device, a wind observation method, and a wind observation system.

### REFERENCE SIGNS LIST

1: sensor, 2: A/D converter, 3: wind observation device, 11: optical oscillator, 12: coupler, 13: optical modulator, 14: optical amplifier, 15: optical circulator, 16: optical antenna, 17: scanner, 18: scanner driver, 19: multiplexing coupler, 20: optical receiver, 31: reception signal acquiring unit, 32: signal integration unit, 32a: first shift processing unit, 32b: first signal integration processing unit, 33: wind vector selecting unit, 34: signal integration unit, 34a: second shift processing unit, 34b: second signal integration processing unit, 35: signal integration unit, 36: signal integration unit, 41: reception signal acquiring circuit, 42: signal integration circuit, 43: wind vector selecting circuit, 44: signal integration circuit, 45: signal integration circuit, 46: signal integration circuit, 51: memory, 52: processor

1. A wind observation device comprising:
processing circuitry configured to
acquire a reception signal of each scattered light beam from a conical scanning sensor to repeatedly emit a laser beam toward a wind observation region and to receive scattered light of each laser beam scattered by aerosol present in the wind observation region;
shift a frequency of each reception signal having been acquired using a frequency shift amount corresponding to each of a plurality of mutually different wind vectors stored in advance, in accordance with each of the plurality of wind vectors and to integrate spectra of the plurality of reception signals after the frequency shift corresponding to each reception signal and each of the wind vectors, for each corresponding wind vector; and
select a wind vector corresponding to a wind vector in the wind observation region from among the plurality of wind vectors on a basis of the integrated spectrum of the reception signals for each wind vector.

2. The wind observation device according to claim 1, wherein the processing circuitry is configured to
calculate a frequency shift amount corresponding to each of the plurality of wind vectors using the plurality of wind vectors.

3. The wind observation device according to claim 1, wherein the processing circuitry is configured to
shift a frequency of each reception signal having been acquired using a frequency shift amount corresponding to each wind vector; and
calculate spectra of a plurality of the reception signals after the frequency shift corresponding to each reception signal and each of the wind vectors and integrate the calculated spectra of the plurality of reception signals for each corresponding wind vector.

4. The wind observation device according to claim 1, wherein the processing circuitry is configured to
calculate spectra of a plurality of reception signals and shift a frequency of the spectra of the plurality of reception signals corresponding each of the plurality of the wind vectors using a frequency shift amount corresponding to each wind vector; and
to integrate the spectra of the plurality of reception signals after the frequency shift corresponding to each reception signal and each of the wind vectors, for each corresponding wind vector.

5. The wind observation device according to claim 1, wherein the processing circuitry is configured to
specify a peak value included in the integrated spectrum of the reception signals for each wind vector, compares peak values of the respective wind vectors with each other, and selects a wind vector corresponding to a wind vector in the wind observation region from among the plurality of wind vectors on a basis of a comparison result of the peak values.

6. The wind observation device according to claim 1, wherein
each of the plurality of wind vectors includes, as three elements, a wind speed value of horizontal wind, a wind speed value of vertical wind, and a wind direction,
in each of the wind vectors, one or more of the three elements are different from those of the other wind vectors, and
the processing circuitry is configured to
output the three elements included in a wind vector in the wind observation region.

7. The wind observation device according to claim 1, wherein
the processing circuitry is configured to
correct the integrated spectrum of the reception signals using a spectrum of a reception signal when there is no noise floor.

8. The wind observation device according to claim 1, wherein
the processing circuitry is configured to
set the plurality of wind vectors on a basis of a wind vector previously selected,
shift a frequency of each reception signal having been acquired using a frequency shift amount corresponding to each of the plurality of set wind vectors corresponding to each of the plurality of wind vectors, and
integrate spectra of the plurality of reception signals after the frequency shift corresponding to each reception signal and each of the wind vectors, for each corresponding wind vector.

9. A wind observation method comprising:
acquiring a reception signal of each scattered light beam from a conical scanning sensor to repeatedly emit a laser beam toward a wind observation region and to receive scattered light of each laser beam scattered by aerosol present in the wind observation region;
shifting a frequency of each reception signal having been using a frequency shift amount corresponding to each of a plurality of mutually different wind vectors stored in advance, in accordance with each of the plurality of wind vectors, and integrating spectra of the plurality of reception signals after the frequency shift corresponding to each reception signal and each of the wind vectors, for each corresponding wind vector; and
selecting a wind vector corresponding to a wind vector in the wind observation region from among the plurality of wind vectors on a basis of the integrated spectrum of the reception signals for each wind vector.

10. A wind observation system comprising:
a conical scanning sensor to repeatedly emit a laser beam toward a wind observation region and to receive scattered light of each laser beam scattered by aerosol present in the wind observation region; and
processing circuitry configured to
acquire a reception signal of each scattered light beam from the sensor;
shift a frequency of each reception signal having been acquired using a frequency shift amount corresponding to each of a plurality of mutually different wind vectors stored in advance, in accordance with each of the plurality of wind vectors and to integrate spectra of the plurality of reception signals after the frequency shift corresponding to each reception signal and each of the wind vectors, for each corresponding wind vector; and
select a wind vector corresponding to a wind vector in the wind observation region from among the plurality of wind vectors on a basis of the integrated spectrum of the reception signals for each wind vector.
